(19) United States
(12) Patent Application Publication
(10) Pub. No.: US 2018/0117719 A1
(43) Pub. Date: May 3, 2018

(54) DEVICE FOR ATTACHING A CORRECTION WEIGHT TO A SHAFT

(71) Applicant: Schenck RoTec GmbH, Darmstadt (DE)

(72) Inventors: Christian MUTH, Fischbachtal (DE); Martin ROGALLA, Darmstadt (DE)

(73) Assignee: Schenck RoTec GmbH, Darmstadt (DE)

(21) Appl. No.: 15/572,250

(22) PCT Filed: May 20, 2016
(86) PCT No.: PCT/EP2016/061455

§ 371 Date: Nov. 7, 2017

(30) Foreign Application Priority Data
May 22, 2015 (DE) 10 2015 108 146.6

(51) Int. Cl. B23K 37/053

(52) U.S. Cl. CPC B23K 37/0533; G01M 1/32

(57) ABSTRACT

A shaft balancing machine for fastening a balancing weight to a shaft has a pincer-like device which includes an upper and a lower pincer unit, wherein each pincer unit is in the form of a two-armed lever. The lever is mounted, so as to be rotatable about a lever center of rotation, on a main body. Each pincer unit has, on a first lever end, a receiving part with at least one receptacle for a balancing weight or a shaft. The levers are connected to one another, at the second lever ends thereof situated opposite the receptacles, by way of a stroke-imparting cylinder. In order that the receptacles can be brought into radial contact with the shaft by way of a stroke of the stroke-imparting cylinder, in each case one guide bar is articulated on the receiving part of each pincer unit and on the main body.

This invention relates to a device for a shaft balancing machine for attaching a correction weight to a shaft, with a clamp-type arrangement comprising an upper and a lower clamping unit, wherein each clamping unit is configured as a two-armed lever.

Shaft balancing machines of the type initially referred to are used for the balancing of rotors as, for example, drive shafts or propeller shafts. For this purpose, after an out-of-balance condition is measured, a correction weight is attached to the shaft by means of a welding or adhesive bonding process. In order to check for correction of the imbalance, a second imbalance measurement is typically taken in the form of an imbalance test measurement. Establishing a correlation between the first imbalance measurement and the second imbalance measurement is however only possible in the absence of any external forces acting on the rotor or the tools clamping the rotor during correction and the imbalance measurement runs. Such forces may develop, for example, if the electrode and the counter-electrode for attaching the correction weight fail to impinge on the rotor precisely at the same time and the impact forces fail to cancel each other out, thereby causing an impact force to act on the rotor.

EP 1 520 161 B1 discloses a welding device for attaching correction weights to rotors, which is configured such that during attachment of the correction weights no external forces act on the rotor, apart from the pressing forces needed for the process. In the device disclosed, a correction weight may be placed on the outer circumference of the rotor and attached there by means of a clamp-type fixture adapted to be positioned longitudinally to a rotor axis. The clamp-type fixture comprises an upper and a lower floating-mounting clamping unit both of which are movable relative to each other by means of a feed unit to increase or reduce their relative distance. As soon as the upper clamping unit engages the rotor, the lower clamping unit is equally moved into contact with the rotor, with the clamp-type fixture being supported by a pneumatic cylinder unit to compensate for its weight. Correction weights may be loaded into holders formed on the lower clamping unit. The correction weight is applied to the shaft by a welding operation. In this process, the upper and the lower clamping unit serve as electrodes. In order to ensure a correct and lasting attachment of the correction weight, it is necessary for a welding force developed by the electrodes to act radially on the correction weight and the shaft, respectively. This is accomplished by a linear drive causing the clamping units to travel to the welding point.

JP S57-137 080 A discloses a pair of welding tongs having two lever arms exhibiting welding tips at their free ends. The lever arms are pivotally mounted on a main body and an actuating cylinder. Actuation of the actuating cylinder enables the pair of welding tongs to be closed and the welding tips to be moved into engagement with the workpiece to be welded.

Furthermore, DE 102 30 207 A1 discloses a device for the attachment of correction weights to drive shafts or propeller shafts, in which the device includes at least one clamp-type arrangement adapted to be positioned longitudinally to the rotor axis to enable a correction weight to be placed on the outer circumference of the rotor for attachment there. The clamp-type arrangement is configured to accommodate several correction weights.

It is an object of the present invention to provide an alternative device for the attachment of correction weights which enables correction weights to be applied to a shaft without external forces acting on the shaft.

This object is accomplished according to the present invention by a device incorporating the features recited in claim 1. Advantageous embodiments of the device are recited in the subclaims.

According to the present invention, this object is accomplished by providing a device for a shaft balancing machine for the attachment of a correction weight to a shaft, with a clamp-type arrangement comprising an upper and a lower clamping unit, wherein each clamping unit is configured as a two-armed lever mounted on a main body for rotation about a fulcrum, and each clamping unit includes on a first lever end a holding fixture having at least one holder for accommodating a correction weight or a shaft, with the levers being connected to each other on their second lever ends opposite the holders through an actuating cylinder, and the holding fixture of each clamping unit and the main body having pivotally mounted on them a respective guide rod enabling the holders to be moved into radial abutment with the shaft by a stroke of the actuating cylinder, wherein the two-armed lever of each clamping unit is configured in such a way that the weights of the two lever arms on either side of the fulcrums are balanced out, thereby accomplishing a uniform weight distribution between the first lever ends and the second lever ends.

The clamping units configured as two-armed levers include a first and a second lever end, with the clamping units having on their first lever ends a respective holding fixture with a holder for accommodating a shaft or a correction weight. Furthermore, a respective guide rod is pivotally mounted on the holding fixture of a clamping unit and the main body. The levers are connected to an actuating cylinder on their second lever ends. In this arrangement, for example, the first upper clamping unit and the second lower clamping unit may be fastened to a piston of the actuating cylinder and, respectively, to a cylinder of the actuating cylinder. The actuating cylinder may be configured as a pneumatic cylinder or as a hydraulic cylinder. It may also be advantageous to provide an actuating cylinder having two pistons traveling in one cylinder. It is also advantageous from the design point of view to connect an electric motor to the actuating cylinder and use it for generation of the stroke.

The stroke of the actuating cylinder causes the lever ends opposite the holders to be moved in the opposite direction, so that the distance between the holders becomes smaller and the holders are in a position to be jointly moved into abutment with the shaft surface. The correction weight held in one of the holders may then be attached to the shaft by adhesive bonding or welding. Following attachment, the holders may be withdrawn from the shaft by a stroke of the actuating cylinder, causing the distance between the second lever ends to become smaller in the process. Due to the configuration of the clamping units as lever arms and the essentially simultaneous engagement of the holders with the shaft, nearly no or hardly any external forces are exerted on the shaft when the correction weight is applied, thereby obviating the necessity of a weight counterbalance of the clamping units. In addition, the clamping units are configured in such a way that the weights of the lever arms on either side of the fulcrums counterbalance each other. This also obviates the need to provide a pneumatic cylinder for weight compensation of the clamp-type arrangement. A structurally simple device for the attachment of correction weights is provided, which affords economy of manufacture and ease of maintenance.

It is particularly advantageous for each holding fixture to be mounted for movement on one of the clamping units through a bearing point, wherein in particular an upper holding fixture is rotatably mounted on the upper clamping unit through a bearing point, and a lower holding fixture is rotatably mounted on the lower clamping unit through a bearing point. The bearing support may be provided, for example, by means of fastening elements such as bolts.

In order to enable the holding fixtures with the holders to be moved into abutment with the shaft radially, guide rods are fastened to the holding fixtures in addition to being also fastened to the main body. It is proposed for each guide rod to have a first end pivotally mounted on the main body through a pivot point and to have a second end pivotally mounted on the holding fixture of a clamping unit through a pivot point, so that the device advantageously comprises at least two guide rods. In one embodiment, the guide rods may be configured in such a way that their pivot points on the main body lie in a plane defined by the fulcrums, in particular a vertical plane. It is also advantageous for one bearing point each, one fulcrum and each two pivot points to be arranged such as to form the corner points of a parallelogram. The upper clamping unit may be configured to be symmetrical to the lower clamping unit, wherein each clamping unit may form with the respective guide rod a parallelogram the corners of which are defined by one bearing point each, one fulcrum, and each two pivot points. In the parallelogram thus defined, in particular the length of a guide rod determined by the pivot points equals the length of a first lever end of a clamping unit, which end is pivotally mounted between a fulcrum and a bearing point. In addition, a plane formed by a pivot point of a guide rod and a bearing point may be arranged parallel to a plane formed by the fulcrums of the clamping units. However, it may also be advantageous for one bearing point each, one fulcrum and each two pivot points to be arranged such as not to form the corner points of a parallelogram, in which case in particular one clamping unit each with the respective guide rod is configured as a four-bar crank mechanism the joints of which are formed by the respective pivot points, bearing points and fulcrums. In this arrangement, particularly the length of a guide rod determined by the pivot points is unequal to the length of a first lever end of a clamping unit between a fulcrum and a bearing point. One advantage of such a configuration resides in that it enables the holders to be moved radially into abutment with the shaft also in an orientation different from the vertical plane, thereby avoiding shunt currents, if any, which may occur during welding when the correction weight fails to be pressed precisely tangentially against the shaft surface.

According to the present invention, the clamping units are displaceable into open limit stop positions lying in a plane with a shaft axis. The advantage of a limit stop position is that it enables the clamping units to be moved into an equal position in relation to the shaft axis. In the limit stop position, the holders of the clamping units are in particular parallel and equidistant to the shaft axis. By means of such a synchronization of the movements of the upper and lower clamping unit it is possible to ensure that the holders engage the shaft circumference simultaneously when the clamping units are moved from the open limit stop position into the closed position abutting the shaft.

Advantageously, the holder for the correction weight or the shaft is configured to exhibit a concave curvature. Because the shape of the holders as well as advantageously also the shape of the correction weight are adapted to conform with the shaft circumference, a significantly improved engagement of the correction weight with the shaft is achievable, which in turn improves the rotational behavior of the shaft.

In order to move the device along the shaft to be balanced and to a correction site, it is suggested that the main body comprise a first guide slide enabling the device to be slidable in the shaft longitudinal direction, that means, the device is displaceable parallel to the shaft axis. The guide slide may be traversable on a guide rail extending parallel to a shaft held in the shaft balancing machine. After the device is moved to the correction site, it can be locked in position by means of a locking device provided on the guide slide.

To permit simple loading of an out-of-balance shaft into the shaft balancing machine, it may also be advantageous for the main body to comprise a further guide slide enabling the device to be displaceable in a direction transverse to the shaft axis. The device is traversable from its position to an offset position, for example, to another guide rail, so that the shaft is accessible for loading into, or unloading from, the shaft balancing machine.

Provision is made for the holding fixture to comprise several holders for correction weights. The holders for correction weights may be loaded with correction weights on a suitable loading station. This may be accomplished by means of an automatic pick-and-place station or manually. Because the holding fixture includes several holders adapted to accommodate correction weights, a second supplementary balancing operation, if necessary, is made possible without the need to re-load the holder in the meantime.

In a preferred embodiment of the present invention, the holders are exchangeably fastened to the holding fixtures. This allows the attachment of different shapes of correction weight.

A correction weight may be attached to the shaft by adhesive bonding or welding. To weld the correction weight to the shaft, the clamp-type arrangement is preferably configured as a welding device and the holders as electrodes. Spot or projection welding processes may be employed. Considering that not only steel but also aluminum materials may find application as correction weights, material-specific welding processes such as MIG or TIG welding processes may also be used.

The present invention will be explained in more detail in the following with reference to embodiments of the invention illustrated in the accompanying drawing. In the drawing,

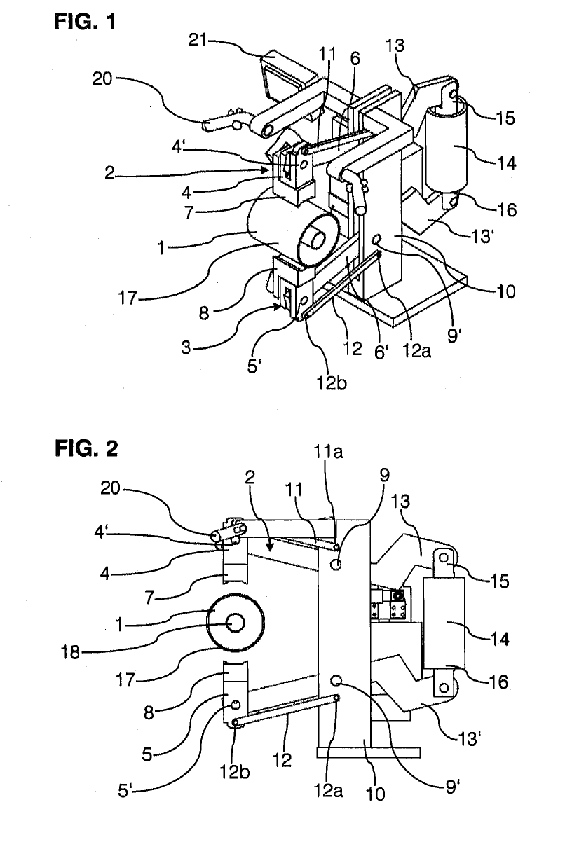

FIG. 1 is a perspective view of a preferred device showing the clamping units open;

FIG. 2 is a side view of FIG. 1;

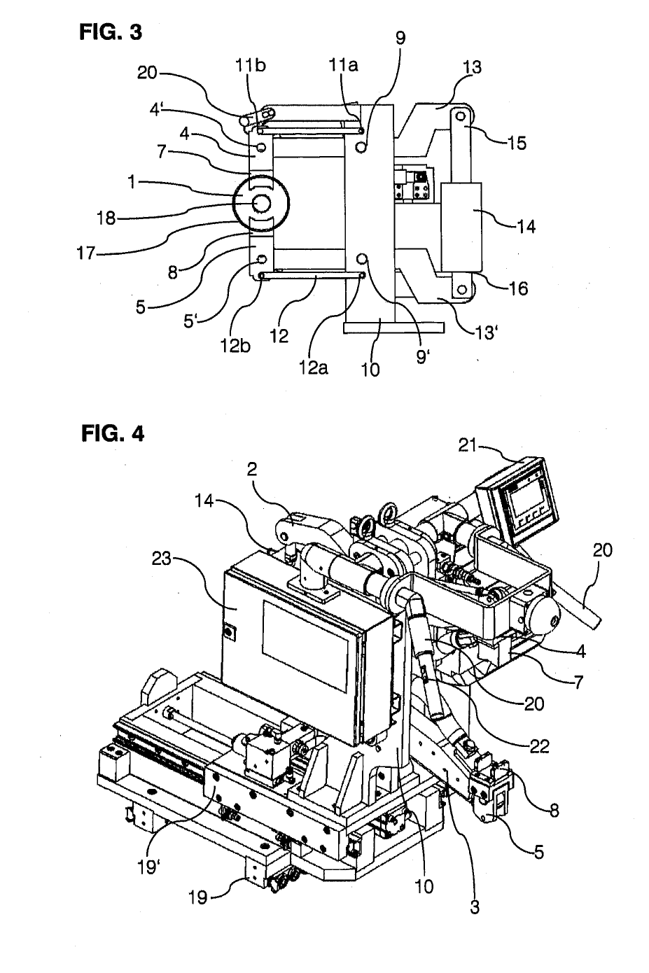

FIG. 3 is a side view of a preferred device showing the clamping units closed; and

FIG. 4 is a schematic view of a preferred device for the application of correction weights.

The device shown in FIGS. 1 to 3 for the attachment of a correction weight to a shaft 1 comprises an upper clamping unit 2 with an upper holding fixture 4 and a lower clamping unit 3 with a lower holding fixture 5. The holding fixtures 4, 5 are arranged on the first lever ends 6, 6′ of the clamping units 2, 3. An upper holding fixture 4 and a lower holding fixture 5 include, respectively, an upper holder 7 and a lower holder 8, the holders 7, 8 being intended to receive the correction weight and, respectively, the shaft 1. The holding fixtures 4, 5 may also be configured such as to enable several holders for correction weights to be fastened, while the Figures show, by way of example, one holding fixture 4, 5 each with just one holder 7, 8. The holding fixtures 4, 5 are rotatably mounted on the lever arms, with the upper holding fixture 4 being rotatably mounted on the upper clamping unit 2 through a bearing point 4′, and the lower holding fixture 5 being rotatably mounted on the lower clamping unit 3 through a bearing point 5′. The bearing points 4′, 5′ of the holding fixtures 4, 5 on the lever arms may be configured, for example, as pin-type connectors, bolts or a suitable bearing support. Considered as bearing points 4′, 5′ within the meaning of the invention are in particular the centers of the rotary bearing supports.

The clamping units 2, 3 are configured as two-armed levers carried on a main body 10 for rotation about a respective fulcrum 9, 9′. The support of the clamping units 2, 3 on the main body 10 may be accomplished by known supporting means as, for example, bolts. Within the meaning of the invention, the fulcrums 9, 9′ designate in particular the centers of the rotary supports. Also secured to the main body 10 are two guide rods 11, 12. In this arrangement, the first guide rod 11 has its first end rotatably mounted on the main body 10 through a pivot point 11a, and its second end on the holding fixture 4 of the upper clamping unit 2 through a pivot point 11b. The second guide rod 12 has its first end rotatably mounted on the main body 10 through a pivot point 12a and its second end to the holding fixture 5 of the lower clamping unit 3 through a pivot point 12b; The pivot points 11a, 12a of the guide rods 11, 12 on the main body may lie in particular in a vertical plane defined by the fulcrums 9, 9′ or may be arranged in an offset relationship thereto. Considered as pivot points 11a, 12a, 11b, 12b within the meaning of the invention are in particular the centers of the rotary supports.

The distance between the pivot point 11a and the fulcrum 9 may be equal to the distance between the pivot point 11b and the bearing point 4′. The same applies to the distance between the pivot point 12a and the fulcrum 9′ which may be equal to the distance between the bearing point 5′ and the pivot point 12b. As a result of this positioning of the guide rods 11, 12, one bearing point 5′, one fulcrum 9′ and two pivot points 12a, 12b combine to form a parallelogram, while one bearing point 4′, one fulcrum 9 and two pivot points 11a, 11b define another parallelogram. The bearing point 5′, the fulcrum 9′ and the two pivot points 12a, 12b and, respectively, the bearing point 4′, the fulcrum 9 and the two pivot points 11a, 11b lie on the corners of the respective parallelogram. The parallelograms thus formed are also maintained when the clamping units 2, 3 are moved.

Furthermore, also the guide rods 11, 12 may be configured such that the distance between the pivot point 11a and the fulcrum 9 is equal to the distance between the pivot point 12a and the fulcrum 9′. However, these distances may also be configured in a different way. The same applies to the distances between the pivot points 11b, 12b of the guide rods and the bearing points 4′ and 5′ of the holding fixtures 4, 5 on the clamping units 2, 3. In the parallelogram thus formed, in particular the length of a guide rod 11, 12 determined by the pivot points 11a, 11b, 12a, 12b is equal to the length of a first lever end 6, 6′ of a clamping unit 2, 3, which end is pivotally mounted between a fulcrum 9, 9′ and a bearing point 4′, 5′. In addition, a plane defined by a pivot point 11b, 12b of a guide rod 11, 12 and a respective bearing point 4′, 5′ may be arranged parallel to a plane defined by the fulcrums 9, 9′ of the clamping units 2, 3. The guide rods 11, 12 have the effect of ensuring that the holding fixtures 4,5 and, correspondingly, also the holders 7, 8, are at all times in vertical alignment and thus able to be moved radially into engagement with the shaft 1.

In another embodiment of the clamp-type arrangement, one bearing point 4′, 5′ each, one fulcrum 9, 9′ and each two pivot points 11a, 11b, 12a, 12b may be arranged such as not to form the corner points of a parallelogram. In this arrangement, in particular the length of a guide rod 11, 12 determined by the pivot points 11a, 11b, 12a, 12b is unequal to the length of the first lever end 6, 6′ of a clamping unit 2, 3, which end is pivotally mounted between a fulcrum 9, 9′ and a bearing point 4′, 5′, so that also the plane defined by a pivot point 11b, 12b of a respective guide rod 11, 12 and a bearing point 4′, 5′ is not arranged parallel to the plane defined by the fulcrums 9, 9′ of the clamping units 2, 3. In this context, a clamping unit 2, 3 combines with the respective guide rod 11, 12 to form a four-bar crank mechanism or linkage mechanism the joints of which are formed by the respective pivot points 11a, 11 b, 12a, 12b, the bearing points 4′, 5′ and the fulcrums 9, 9′.

On the second lever ends 13, 13′ opposite the first lever ends 6, 6′ of the clamping units 2, 3, the clamping units 2, 3 configured as levers are connected with each other through an actuating cylinder 14. The second lever end 13, 13′ of each clamping unit 2, 3 may be angled relative to the first lever end 6, 6′ in order to enable actuating cylinders of varying size, for example, to be fastened to the clamping units 2, 3. In this arrangement, the upper clamping unit 2 and the lower clamping unit 3 are rotatably mounted on the piston 15 of the actuating cylinder 14 and, respectively, the cylinder 16 of the actuating cylinder 14. The actuating cylinder 14 may be configured as a pneumatic cylinder or hydraulic cylinder. When pressure is applied to the actuating cylinder 14, the second lever ends 13, 13′ of the clamping units 2, 3 are urged apart, causing the distance between the holders 7, 8 to be reduced until eventually the holders 7, 8 jointly engage the surface 17 of the shaft 1.

In addition, the clamping units 2, 3 are configured such that a uniform weight distribution is achieved between the first lever ends 6, 6′ and the second lever ends 13, 13′, which is accomplished, for example, by providing for weight compensation of the lever arms on either side of the fulcrums 9, 9′. This makes it possible to obviate the need for a weight counterbalance of the clamping units 2, 3 using, for example, a further pneumatic cylinder, which significantly simplifies the technical complexity of the device of the invention and, in consequence, also its manufacture and assembly. When required, however, a counterweight fixedly mounted on the clamping units 2, 3 may serve as weight counterbalance.

Provided that the holders 7, 8 are configured as electrodes and a correction weight is to be fastened to the shaft 1 by welding, the configuration of the clamp-type arrangement ensures that a welding force impinges on the shaft 1 precisely radially. The clamping units 2, 3 are configured such that the welding force is introduced into the correction weight to be applied with as few angular errors as possible. It is however equally possible to apply correction weights to the shaft 1 by adhesive bonding. The holders 7, 8 for the correction weight or the shaft 1 are shaped to conform to the shaft circumference and exhibit a concave curvature. Also the shape of the correction weights typically has a concave curvature.

The clamping units 2, 3 are displaceable into open limit stop positions lying in a plane with the shaft axis 18, as shown in FIGS. 1 and 2. In the limit stop position the holders 7, 8 of the clamping units 2, 3 are aligned parallel to each other and equidistant to the shaft axis 18, with the distance between the holders 7, 8 being at its maximum in this position. The limit stop causes the clamping units 2, 3 configured as lever arms to occupy a symmetrical position relative to the shaft axis 18. In case friction prevents the holders 7, 8 or the lever arms from being aligned symmetrically to the shaft axis 18, their displacement into the limit stop position enables them to be returned to an equal position relative to the shaft axis.

The device may be configured to suit a variety of shaft diameters. The Figures show, by way of example, a shaft section having a relatively small and a relatively large shaft diameter. The device is configured such that the clamping units 2, 3, particularly the first lever ends 6, 6′ of the clamping units 2, 3, are parallel to each other, and the clamping units 2, 3 are horizontally aligned when the holders 7, 8 are in engagement with a computed mean shaft diameter. Proceeding from the closed position abutting the shaft 1, this enables the necessary movement of the clamping units 2, 3 into the limit stop position to be kept as short as possible.

In order to determine an out-of-balance condition of a shaft 1 and perform an imbalance correction, the shaft 1 to be balanced is seated in supporting devices, not shown in greater detail, in the shaft balancing machine and is rotated by means of a drive. Sensors, such as distance sensors, for example, detect the rotational behavior of the shaft 1 and transmit measurement data to an evaluation unit which then computes an imbalance, if any, and the appropriate correction site and a necessary corrective mass. Correction of the imbalance, that is, the application of correction weights to the correction sites, is performed by the device of the invention. The device may be integrated into the balancing machine as a separate unit.

In order to be able to displace the device to the appropriate correction site, the device is mounted on a first movable guide slide 19—as shown in FIG. 4—, which enables the device to travel in the shaft longitudinal direction. The guide slide 19 may be mounted for displacement on a guide rail extending longitudinally to the shaft axis 18. The guide slide 19 is mounted on the main body 10 of the device. Still further, the device is displaceable or relocatable in a direction transverse to the shaft axis 18 to allow loading and unloading of the shaft 1 into and from its supporting device. For this purpose, the device includes another guide slide 19′ which is arranged in a direction transverse to the first guide slide 19 and allows a longitudinal displacement of the device.

To attach one or more correction weights by means of the device, the clamping units 2, 3 are arranged on either side of the shaft 1 such that the centers of the holding fixtures 4, 5 with the holders 7, 8 for correction weights lie in a plane of the shaft axis 18. The correction weight may be loaded into the lower clamping unit 3 or in its corresponding lower holder 8. Loading the correction weight may be performed manually or automatically. Because the holders 7, 8 are configured as exchangeable parts, their exchange is easily possible to accommodate different shaft diameters. On the other hand, this also enables the holders 7, 8 to be adapted to different shapes of correction weights.

Pressure application of the actuating cylinder 14 then moves the holders 7, 8 of the clamping units 2, 3 jointly into abutment with the shaft surface 17. The correction weight in the lower holder 8 is pressed against the shaft surface 17 and fastened by means of a welding process, for example, with the lower and upper holders 7, 8 operating as electrodes. Following attachment, the clamping units 2, 3 are moved into the open limit stop position. The device may then be moved to the next correction position or correction plane by displacement of the device parallel to the shaft 1. When all the necessary correction weights are applied to the shaft 1 to eliminate any imbalance, a check measurement run is performed to check for imbalance correction. If necessary, further correction weights may be applied to the shaft 1 by means of the device. Otherwise, the device may be moved by means of the guide slide 19′ to unload the shaft 1 and load another out-of-balance shaft into the balancing machine.

The device may be equipped with a handle set 20 which may be used as control device for manually positioning and operating the device. An operator may move the device to the correction site by means of the handle set 20, which may include the possibility for air-assisted positioning to facilitate displacement of the device. The length of travel of the device may be limited by a manually adjustable limit stop. A visual display unit 21 may be arranged on the device to display information relating to the welding process, for example. Once the device is positioned, the operator may load one or more necessary correction weights into the lower holder 8 or, where applicable, place it on the shaft 1. The welding process may be released by a switch 22 on the handle set 20. The handle set 22 is connected to a control unit 23. On actuation of the switch 22, the clamping units 2, 3 close pneumatically, weld and open again on completion of the welding process. The operator may then unlock the device and, where necessary, move it to the next correction site.

It will be understood that other known fastening devices, such as adhesive devices, may be substituted for, or employed in addition to, the welding device as herein represented and described.

It is also within the scope of the present invention to spatially separate the device for the attachment of correction weights from the balancing machine should this prove advantageous for a manufacturing line, for example. In this event, the shaft is transferred from the balancing machine to the device, including the transmission of information about any imbalance determined or correction data resulting therefrom.

1-13. (canceled)

14: A device for a shaft balancing machine for the attachment of a correction weight to a shaft, with a clamp-type arrangement comprising an upper and a lower clamping unit, wherein each clamping unit is configured as a two-armed lever mounted on a main body for rotation about a fulcrum, and each clamping unit includes on a first lever end a holding fixture having at least one holder for accommodating a correction weight or a shaft, said levers being connected to each other on their second lever ends opposite the holders through an actuating cylinder, and the holding fixture of each clamping unit and the main body having pivotally mounted on them a respective guide rod enabling the holders to be moved into radial abutment with the shaft by a stroke of the actuating cylinder, wherein the two-armed lever of each clamping unit is configured in such a way that the weights of the two lever arms on either side of the fulcrums are balanced out, thereby accomplishing a uniform weight distribution between the first lever ends and the second lever ends.

15: The device according to claim 14, wherein an upper holding fixture is movably mounted on the upper clamping unit through a bearing point, and a lower holding fixture is movably mounted on the lower clamping unit through a bearing point.

16: The device according to claim 14, wherein each guide rod has a first end pivotally mounted on the main body through a pivot point and a second end pivotally mounted on the holding fixture of a clamping unit through a pivot point.

17: The device according to claim 16, wherein one bearing point each, one fulcrum and each two pivot points are arranged such as to form the corner points of a parallelogram.

18: The device according to claim 16, wherein one clamping unit each with the respective guide rod is configured as a four-bar crank mechanism the joints of which are formed by the respective pivot points, bearing points and fulcrums.

19: The device a according to claim 14, wherein the clamping units are displaceable into open limit stop positions lying in a plane with a shaft axis.

20: The device according to claim 19, wherein in the limit stop position the holders of the clamping units are parallel and equidistant to the shaft axis.

21: The device according to claim 14, wherein the holder for the correction weight or for the shaft is configured to exhibit a concave curvature.

22: The device according to claim 14, wherein the holding fixture comprises several holders for correction weights.

23: The device according to claim 14, wherein the holders are exchangeably fastened to the holding fixtures.

24: The device a according to claim 14, wherein the main body comprises a first guide slide enabling the device to be slidable in the shaft longitudinal direction.

25: The device according to claim 14, wherein the main body comprises a further guide slide enabling the device to be displaceable in a direction transverse to the shaft axis.

26: The device according to claim 14, wherein the clamp-type arrangement is configured as a welding device and the holders as electrodes.
